(19) United States
(12) Patent Application Publication
(10) Pub. No.: US 2002/0150149 A1
(43) Pub. Date: Oct. 17, 2002

(54) Code detection circuit and code detection method

(76) Inventor: Yoshihiro Tanno, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/129,957

(22) PCT Filed: Sep. 26, 2001
(86) PCT No.: PCT/JP01/08379

(30) Foreign Application Priority Data
Sep. 29, 2000 (JP) 2000-299846

(51) Int. Cl. H04K 1/00

(52) U.S. Cl. 375/147

(57) ABSTRACT

Each of multipliers (1, 2) is used to respectively multiply reception data by a first cycle code generated in a first cycle code generator (3) and by an inverted first cycle code obtained by inverting the first cycle code in a polarity judging section (4). An output from each of the multipliers (1, 2) is supplied to 16 selectors (5) associated with 16 types of Hadamard Sequence patterns. To the selectors (5) are respectively fed selection signals of 16 patterns determined by figuring out exclusive ORs from a code obtained by converting each chip in a second cycle code from “1” to “0” and “−1” to “1” with respect to each of 16 types of the Hadamard Sequence patterns. The selectors (5) select and output each of the multipliers (1, 2) based on the selection signals so that outputs are accumulated in accumulators (7).

### TECHNICAL FIELD

The present invention relates to a code detection circuit and a code detection method for use in second search processing and the like in a W-CDMA type mobile wireless communication system.

### BACKGROUND ART

In the W-CDMA type mobile wireless communication systems, there is executed the so-called second search processing for detecting one of 16 codes to which a mixed Hadamard Sequence in a Secondary Synchronization Code corresponds.

The Secondary Synchronization Code is a code obtained from an exclusive OR (EX-OR) of a Golay Sequence as a first code and a Hadamard Sequence as a second code.

The Golay Sequence is such a fixed pattern as shown by S14 in FIG. 5. This Golay Sequence is constituted by multiplying such a first cycle code as shown by S12 in FIG. 5 by such a second cycle code as shown by S13 in FIG. 5. The first cycle code is obtained by repeating a first fixed pattern A 16 times. The first fixed pattern A is obtained by arranging 16 chips in a predetermined order as shown by S11 in FIG. 5, each chip of which is indicative of “1” or “−1”. The first cycle code has, therefore, a 256-bit length.

Furthermore, the second cycle code is a code of a 16-chip length obtained by arranging 16 chips in a predetermined order, each chip of which is indicative of “1” or “−1”. In other words, the chip cycle of the second cycle code is 1/16 of the chip cycle of the first fixed pattern A. The first cycle code has, therefore, a faster rate than that of the second cycle code. Thus, the rate of the first cycle code will be referred to as a fast rate, and that of the second cycle code is referred to as a slow rate.

As described above, the Golay Sequence is a code obtained by repeating the repristination or inversion rotation of the first fixed pattern A in accordance with a given pattern to arrange the patterns 16 times. The Golay Sequence has a 256-chip length and a chip cycle equal to that of the first cycle code.

On the other hand, Hadamard Sequence patterns composed of 16 kinds of bit arrangements as shown in FIG. 6 exist as the Hadamard Sequence. Each of these Hadamard Sequence patterns has a 16-bit length. Hadamard Sequence numbers from “1” to “16” are respectively given to these 16 Hadamard Sequence patterns. An arbitrary one of the 16 Hadamard Sequence patterns is selectively used for the Hadamard Sequence. The Hadamard Sequence has a bit rate similar to the chip rate of the second cycle code, i.e., the slow rate, as indicated by S15 in FIG. 5. It is to be noted that “b0” to “b15” in S15 of FIG. 5 denote respective bits constituting one Hadamard Sequence.

FIG. 7 is a block diagram showing a conventional structure of a second search circuit for detecting which Hadamard Sequence pattern is included in the above-described Secondary Synchronization Code.

The second search circuit shown in the drawing includes: a Golay Sequence generator 51; multipliers 52 (52-1, 52-2); accumulative adders 53 (53-1, 53-2); 16-stage shift registers 54 (54-1, 54-2); and First Hadamard circuits 55 (55-1, 55-2).

The above-mentioned Golay Sequence is first generated in the Golay Sequence generator 51, and the obtained sequence is multiplied by respective Secondary Synchronization Codes received by I-channel and Q-channel in the multipliers 52-1 and 52-2.

Since one bit of the Hadamard Sequence corresponds to a 16-chip period of the Golay Sequence, outputs from the multipliers 52-1 and 52-2 are accumulated in the accumulation adders 53-1 and 53-2 in accordance with each 16-chip period of the Golay Sequence. Thereafter, the obtained results are fetched into the 16-stage shift registers 54-1 and 54-2, thereby extracting the 16-bit Hadamard Sequence pattern.

Correlation values between the thus extracted Hadamard Sequence pattern and the 16 Hadamard Sequence patterns are obtained by the First Hadamard circuits 55-1 and 55-2. The First Hadamard circuits 55-1 and 55-2 respectively outputs the correlation values between the extracted Hadamard Sequence pattern and the 16 Hadamard Sequence patterns, i.e., 16 correlation values. Therefore, based on the largeness relationship between these 16 correlation values, it is possible to make judgment upon which Hadamard Sequence pattern is included in the Secondary Synchronization Code.

The First Hadamard circuits 55 share arithmetic operation units as much as possible so that the arithmetic operation units has a tree structure, in accordance with each of the 16 Hadamard Sequence patterns. Since the arithmetic operation units are structured in the form of a tree in this manner, a circuit scale is very large. Moreover, a large number of the arithmetic operation units leads to an extremely large amount of electric power consumption.

### DISCLOSURE OF INVENTION

Accordingly, it is an object of the present invention to execute correlation vale calculation for code detection with a small circuit scale and a small amount of electric power consumption.

This aim is achieved by the following code detection circuit.

According to the present invention, there is provided a code detection circuit for obtaining respective correlation values of i types (i is a positive integer not less than 2) of variable patterns to a third code in order to detect one of the i types of variable patterns corresponding to only one variable pattern included in the third code obtained from exclusive ORs of a first code and a second code, wherein under the following conditions:

(1) the first code is constituted by multiplying a first cycle code by a second cycle code;

(2) the first cycle code is obtained by repeatedly arranging n patterns (n is a positive integer) of a first fixed pattern having an m-chip (m is a positive integer) length;

(3) the first fixed pattern is obtained by arranging m chips, each of which is indicative of “1” or “−1”, in a predetermined order;

(4) the second cycle code is constituted by a second fixed pattern having a chip cycle which is m times larger than that of the first cycle code and having an n-chip length;

(5) each chip of the second fixed patter represents normality/inversion of the first fixed pattern;

(6) the second code is obtained by repeatedly arranging p (p is a positive integer) variable patterns each of which has the same chip cycle as that of the second cycle code and has an n/p-bit length; and

(7) the i types of variable patterns are obtained by arranging n/p bits of “0” or “1” in each different order,

the code detection circuit comprises:

first code converting means for respectively outputting chips of the third code corresponding to a period in which the first cycle code is “1” without changing the polarity and chips of the third code corresponding to a period in which the first cycle code is “−1” with the polarity being inverted when the first cycle code is synchronized with the third code;

second code converting means for respectively outputting chips of the third code corresponding to a period in which the first cycle code is Ill, with the polarity being inverted and chips of the third code corresponding to a period in which the first cycle code is “−1” without changing the polarity when the first cycle code is synchronized with the third code;

selection pattern outputting means for respectively outputting i selection patterns with respect to each of the i types of variable patterns in synchronization with the third code in parallel, the i selected patterns being formed by figuring out exclusive ORs from codes obtained by converting each chip in the second cycle code from “1” to “0” and from “−1 to “1”;

i selecting means which are respectively associated with i selection patterns outputted from the selection pattern outputting means and respectively selects and outputs an output from the first code converting means when an associated selection pattern is “0” and an output from the second code converting means when an associated selection pattern is “1”; and

i accumulating means which are provided so as to be respectively associated with the i selecting means and accumulates an output from an associated selecting means.

The above aim can be realized by the following code detection method.

According to the present invention, there is provided a code detection method for obtaining respective correlation values of i types (i is a positive integer not less than 2) of variable patterns to a third code in order to detect one of the i types of variable patterns corresponding to only one variable pattern included in the third code obtained from exclusive ORs of a first code and a second code, wherein under the following conditions:

(1) the first code is constituted by multiplying a first cycle code by a second cycle code;

(2) the first cycle code is obtained by repeatedly arranging n patterns (n is a positive integer) of a first fixed pattern having an m-chip (m is a positive integer) length;

(3) the first fixed pattern is obtained by arranging m chips each of which is indicative of “1” or “−1”, in a predetermined order;

(4) the second cycle code is constituted by a second fixed pattern having a chip cycle which is m times larger than that the first cycle code and having an n-chip length;

(5) each chip of the second fixed patter represents normality/inversion of the first fixed pattern;

(6) the second code is obtained by repeatedly arranging p (p is a positive integer) variable patterns each of which has the same chip cycle as that of the second cycle code and has an n/p-bit length; and

(7) the i types of variable patterns are obtained by arranging n/p bits of “0” or “1” in each different order,

the code detection method comprises:

a first code converting step for respectively outputting chips of the third code corresponding to a period in which the first cycle code is “1” without changing the polarity and chips of the third code corresponding to a period in which the first cycle code is “−1” with the polarity being inverted when the first cycle code is synchronized with the third code;

a second code converting step for respectively outputting chips of the third code corresponding to a period in which the first cycle code is “1” with the polarity being inverted and chips of the third code corresponding to a period in which the first cycle code is “−1” without changing the polarity when the first cycle code is synchronized with the third code;

a selection pattern outputting step for respectively outputting i selection patterns with respect to each of the i types of variable patterns in synchronization with the third code in parallel, the i selection patterns being formed by figuring out exclusive ORs from codes obtained by converting each chip in the second cycle code from “1” to “0” and from “−1” to “1”;

a selecting step for respectively selecting and outputting an output from the first code converting step when an associated selection pattern is “0” and an output from the second code converting step when an associated selection pattern is “1” in accordance with each of i selection patterns outputted at the selection pattern outputting step; and

an accumulating step for respectively accumulating i selected outputs at the selecting step.

### BRIEF DESCRIPTION OF DRAWINGS

FIG. 1 is a block diagram showing a structure of a second search circuit constituted by applying a code detection circuit according to a first embodiment of the present invention;

FIG. 2 is a view showing an input data selection pattern determined in accordance with each of 16 types of Hadamard Sequence patterns;

FIG. 3 is a timing chart showing the state of operations of multipliers I and multipliers 2 and selectors 5 depicted in FIG. 1;

FIG. 4 is a block diagram showing a structure of a second search circuit constituted by applying a code detection circuit according to a second embodiment of the present invention;

FIG. 5 is a view for illustrating a conformation of a Secondary Synchronization Code in the W-CDMA system;

FIG. 6 is a view showing a Hadamard Sequence pattern; and

FIG. 7 is a block diagram showing a conventional structure of a second search circuit.

### BEST MODE FOR CARRYING OUT OF THE INVENTION

Preferred embodiments according to the present invention will now be described hereinafter with reference to the accompanying drawings.

(First Embodiment)

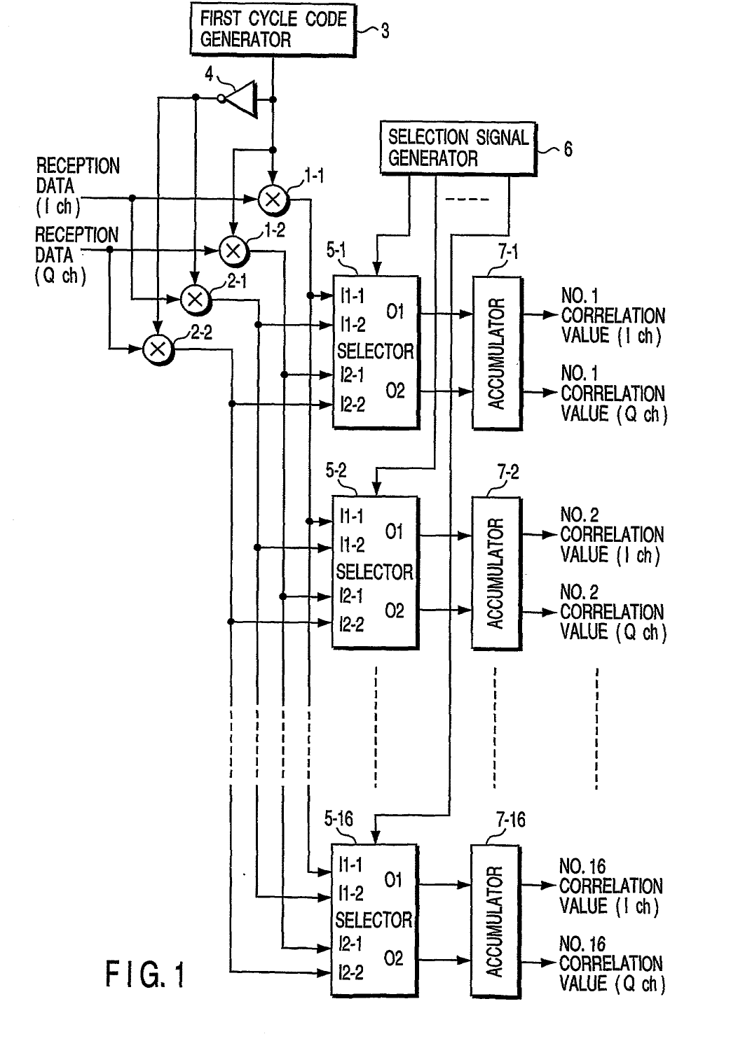

FIG. 1 is a block diagram showing a structure of a second search circuit constituted by applying a code detection circuit according to this embodiment.

As shown in this drawing, the second search circuit according to this embodiment includes: multipliers 1-1 and 1-2; multipliers 2-1 and 2-2; a first cycle code generator 3; a polarity inverter 4; selectors 5-1 to 5-16; a selection signal generator 6; and accumulators 7-1 to 7-16.

Since the multipliers 1-1 and 1-2 are similar in function, they will be referred to simply as “multipliers 1” unless the difference between them in important. By the same token, the multipliers 2-1 and 2-2 will be referred to as “multipliers 2”, the selectors 5-1 to 5-16 will be referred as selectors 5”, and the accumulators 7-1 to 7-16 will be referred as “accumulators 7”.

To the multipliers 1 and multipliers 2 receive ha I-channel reception data and Q-channel reception data respectively. That is, the I-channel reception data is inputted to the multipliers 1-1 and 2-1. Further, the Q-channel reception data is inputted to the multipliers 1-2 and 2-2. A first cycle code generated by the first cycle code generator 3 is supplied to each of the multipliers 1. An inverted first cycle code generated by the polarity inverter 4 is given to each of the multipliers 2. The respective multipliers 1 and multipliers 2 multiply their two inputs. Thus, the multipliers 1 execute processing for multiplying the reception data by the first cycle code. Furthermore, the multipliers 2 execute processing for multiplying the reception data by the inverted first cycle code.

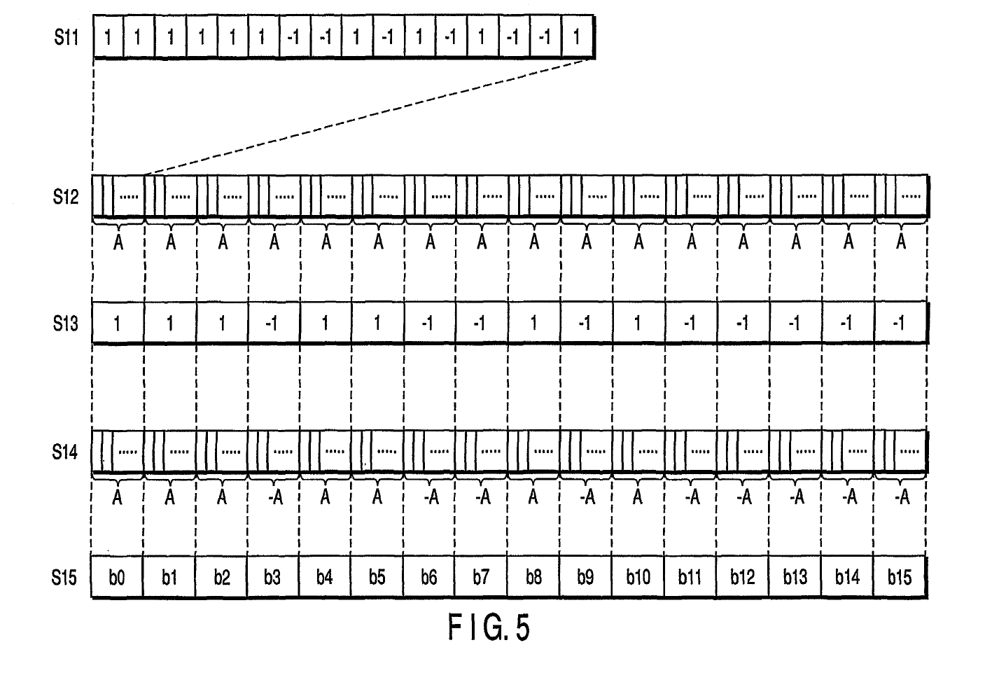

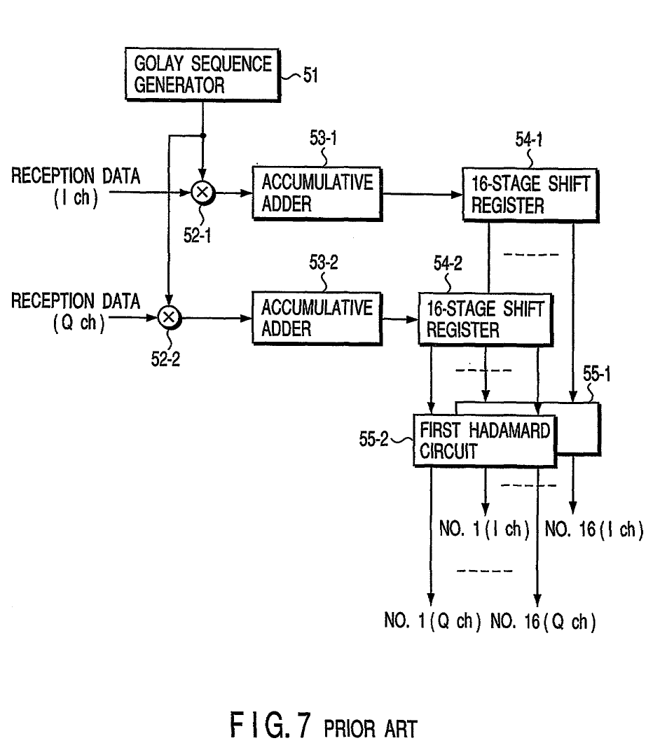

The first cycle code generator 3 generates the above-described first cycle code shown in FIG. 5 and outputs the obtained code in synchronization with a timing of a Secondary Synchronization Code in the reception data.

The polarity inverter 4 inverts the polarity of each chip in the first cycle code generated by the first cycle code generator 3 to produce the above-described inverted first cycle code and supplies the obtained code to the multipliers 2.

16 selectors 5 are provided, whose number is equal to a number of Hadamard Sequence patterns. Each of these selectors 5 has input terminals I1, I2 of two systems. The input terminal of each system is provided with two input terminals I1-1, I1-2 and I2-1, I2-2. A sum total of the input terminals is, therefore, 4. The input terminals II are a system for inputting data concerning I-channel. An output from the multiplier 1-1 is supplied to the input terminal I1-1, while an output from the multiplier 2-1 is fed to the input terminal I1-2. The input terminals I2 are a system for inputting data concerning Q-channel. An output from the multiplier 1-2 is supplied to the input terminal I2-1 and an output from the multiplier 2-2 is fed to the input terminal I2-2. The selector 5 selects the input terminals I1-I and I2-1 when a selection signal supplied from the selection signal generator 6 is indicative of “0” and selects the input terminals I1-2 and I2-2 when a selection signal is indicative of “1”, respectively. The selector 5 outputs from an output terminal O1 data inputted to one selected terminal of the input terminals I1-1 and I1-2. Further, the selector 5 outputs from an output terminal O2 data inputted to one selected terminal of the input terminals I2-1 and I2-2.

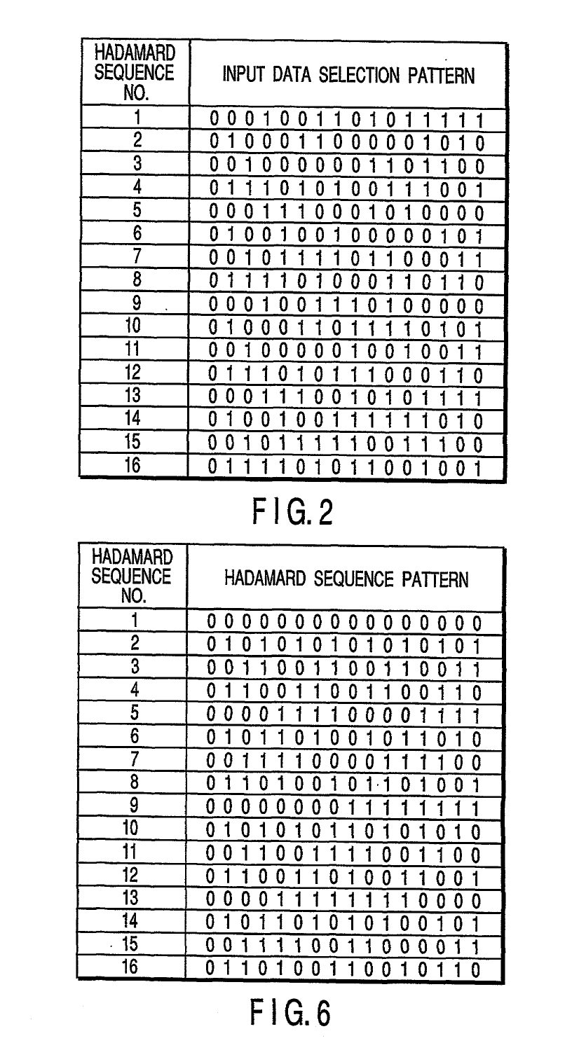

The selection signal generator 6 generates in parallel selection signals according to 16 types of input data selection patterns determined as shown in FIG. 2 and supplies these signals to each selector 5. The input data selection pattern consists of 16 bits. The selection signal generator 6 outputs the input data selection pattern in synchronization with a timing of a Secondary Synchronization Code at a slow rate in order to generate each selection signal. Here, each input data selection pattern shown in FIG. 2 is determined with respect to each Hadamard Sequence pattern with “No.” shown in FIG. 2 associated with that input data selection pattern by figuring out exclusive ORs from a code obtained by respectively converting each chip in the second cycle code from “1” to “0” and “−1” to “1”. Each of these input data selection patterns is, therefore, associated with each Hadamard Sequence pattern and represents a pattern of the selection signal supplied to the selector associated with the same Hadamard Sequence pattern. It is to be noted that the selection signal generator 6 may be constituted so as to generate such an input data selection pattern every time the arithmetic calculation is executed, or a data table showing the patterns in FIG. 2 may be prepared and stored in, e.g., a RAM or a ROM.

16 accumulators 7 are provided, whose number is equal to a number of the Hadamard Sequence patterns. The accumulators 7 and the selectors 5 form pairs. To each accumulator 7 are supplied to respective output data from the output terminals O1 and O2 of the selector 5 which forms a pair with this accumulator 7. The accumulator 7 respectively accumulates values of data from these two systems. The accumulator 7 respectively outputs as a correlation value concerning I-channel an accumulation vale of output data values from the output terminal O1 of the selector 5 and outputs as a correlation value concerning Q-channel an accumulation value of output data values from the output terminal 02 of the selector 5. It is to be noted that the accumulators 7-1 to 7-16 are associated with the respective Hadamard Sequence patterns of No. 1 to No. 16, and the two correlation values to be outputted concern the associated Hadamard Sequence patterns.

Description will now be given as to the operation of the second search circuit having the above-described arrangement. For the sake of convenience, there is assumed an ideal state in which there is no influence of radio transmission due to, e.g., fading and phase rotation in a transmission path. Although the reception data represented by multiple bits per one chip is thus typically inputted so as not to be affected by noise components, description will be given herein on the assumption that the data identified as “1” or “−1” is inputted.

Paying notice to every 16 chips, the Secondary Synchronization Code is obtained from EX-ORs of the pattern A or the pattern −A and “0” or “1” as apparent from FIG. 5, and there are hence only four patterns, i.e., A×1, A×0, −A×1 and −A×0. However, since A×1 and −A×0, or A×0 and −A×1 are the same pattern, there are actually only two patterns, i.e., A or −A.

Therefore, the first cycle code in which the pattern A is repeated 16 times or the inverted first cycle code in which the pattern −A is repeated 16 times is generated by the first cycle code generator 3 and the polarity inverter 4. These codes are then multiplied by the reception data of the respective channels in the multipliers 1 and the multipliers 2. One of outputs from the multipliers 1 and the multipliers 2, therefore, becomes necessarily “all 1” with respect to each of 16 cycles for every 16 chips in the Secondary Synchronization Code.

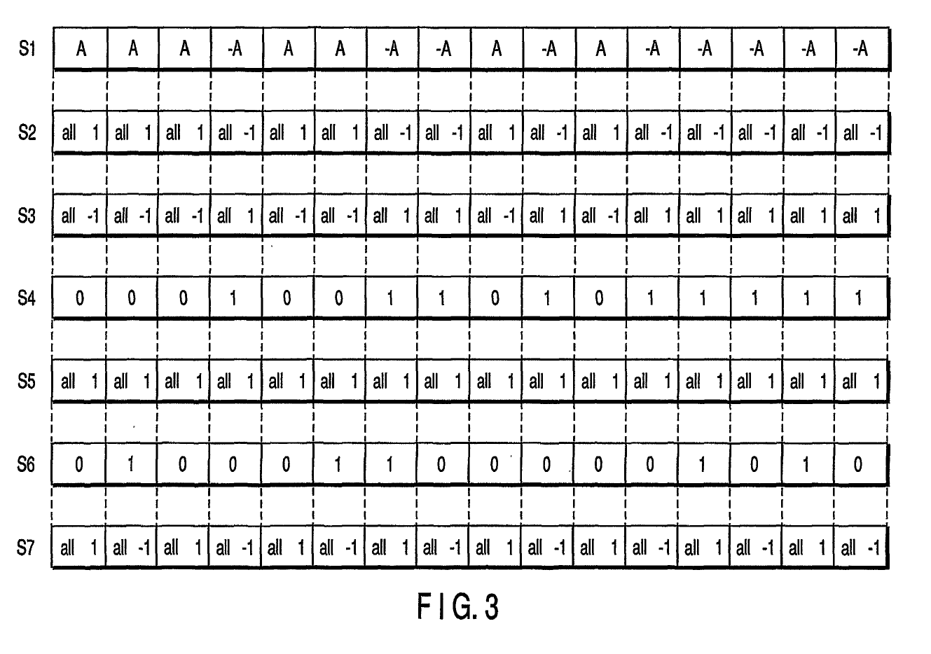

Specifically, if the Hadamard Sequence code included in the Secondary Synchronization Code becomes the No. 1 code, that Hadamard Sequence code is “all 0” as shown in FIG. 6. Therefore, as the Secondary Synchronization Code, a Golay Sequence appears as it stands. That is, the Secondary Synchronization Code in this case becomes a code having a pattern such as indicated by S1 in FIG. 3.

Outputs from the multipliers 1 and the multipliers 2 enter the states indicated by S2 and S3 in FIG. 3, and the output from the multipliers 1 becomes “all 1” in each of the first, second, third, fifth, sixth, ninth and 11th 16-chip periods. Meanwhile, the output from the multipliers 2 becomes “all 1” in each of the remaining fourth, seventh, eighth, 10th, and 12th to 16th 16-chip periods.

Either of outputs from the multipliers 1 and the multipliers 2 in which “all 1” appears in each 16-chip period is determined by a pattern obtained by figuring out EX-ORs from a code obtained by converting each chip in the second cycle code from “1” to “0” and “−1” to “1” with respect to the Hadamard Sequence pattern.

Accordingly, if the output from the multipliers 1 or the multipliers 2 is selected with a pattern associated with each of 16 types of the Hadamard Sequence patterns in the selector 5, “all 1” is outputted in the entire Secondary Synchronization Code period (256-chip period) only to the selector 5 which has made selection with a pattern associated with each Hadamard Sequence pattern included in the Secondary Synchronization Code.

Specifically, to the selector 5-1 is supplied such a selection signal as indicated by S4 in FIG. 3 in accordance with the input data selection pattern shown in FIG. 2 associated with the No. 1 Hadamard Sequence pattern. The selector 5 is designed to select and supply an output from the multipliers 1 when the selection signal is indicative of “0” and an output from the multipliers 2 when the same is indicative of “1”. The selector 5-1, therefore, selects and supplies an output from the multipliers I in each of the first, second, third, fifth, sixth, ninth and 11th 16-chip periods in which the selection signal is indicative of “0” and an output from the multipliers 2 in each of the fourth, seventh, eighth, 10th and 12th to 16th 16-chip periods in which the selection signal is indicative of “1”. As a result, if the Hadamard Sequence pattern included in the Secondary Synchronization Code is the No. 1 pattern and the outputs from the multipliers 1 and multipliers 2 are as indicated by S2 and S3 in FIG. 3, the output from the selector 5-1 becomes “all 1” in all the 16-chip periods as indicated by S5 in FIG. 3.

On the other hand, a selection signal such as indicated by S6 in FIG. 3 is supplied to the selector 5-2 in accordance with the input data selection pattern shown in FIG. 2 in compliance with the No. 2 Hadamard Sequence pattern, for example. The selector 5-2, therefore, selects and supplies outputs of the multipliers 1 in each of the first, third to fifth, eighth to 12th, 14th and 16th 11-chip periods in which the selection signal is indicative of “0”. Further, the selector 5-2 selects and supplies outputs of the multipliers 2 in each of the second, sixth, seventh, 13th and 15th 5-chip periods in which the selection signal is indicative of “1”. As a result, if the Hadamard Sequence pattern included in the Secondary Synchronization Code is the No. 1 pattern and the outputs from the multipliers 1 and multipliers 2 are as indicated by S2 and S3 in FIG. 3, the selector 5-2 supplies the output in which the “all 1” period and the “all −1” period are mixed as indicated by S7 in FIG. 3.

Such outputs from the selectors 5 are accumulated in the respective accumulators 7. Therefore, an accumulation value of an accumulator 7 which receives the selector output which is associated with the Hadamard Sequence pattern included in the Secondary Synchronization Code and is “all 1” in all the 16-chip periods as described above becomes larger than an accumulation value of another accumulator 7. This enables acquisition of an appropriate correlation value for identifying the Hadamard Sequence pattern.

As mentioned above, according to this embodiment, calculation of the correlation value can be realized by a combination of circuits which execute simple processing without using a complicated arithmetic operation circuit such as a First Hadamard circuit. There can be consequently achieved a second search circuit which can operate with the small circuit scale and the lower power consumption.

(Second Embodiment)

Although the above has described the first embodiment in which data identified as “1” or “−1” is inputted for easy understanding of the principle of the present invention, description will now be given as to an embodiment preferable to the case where reception data consisting of multiple bits represented by complements of 2 is inputted hereinafter.

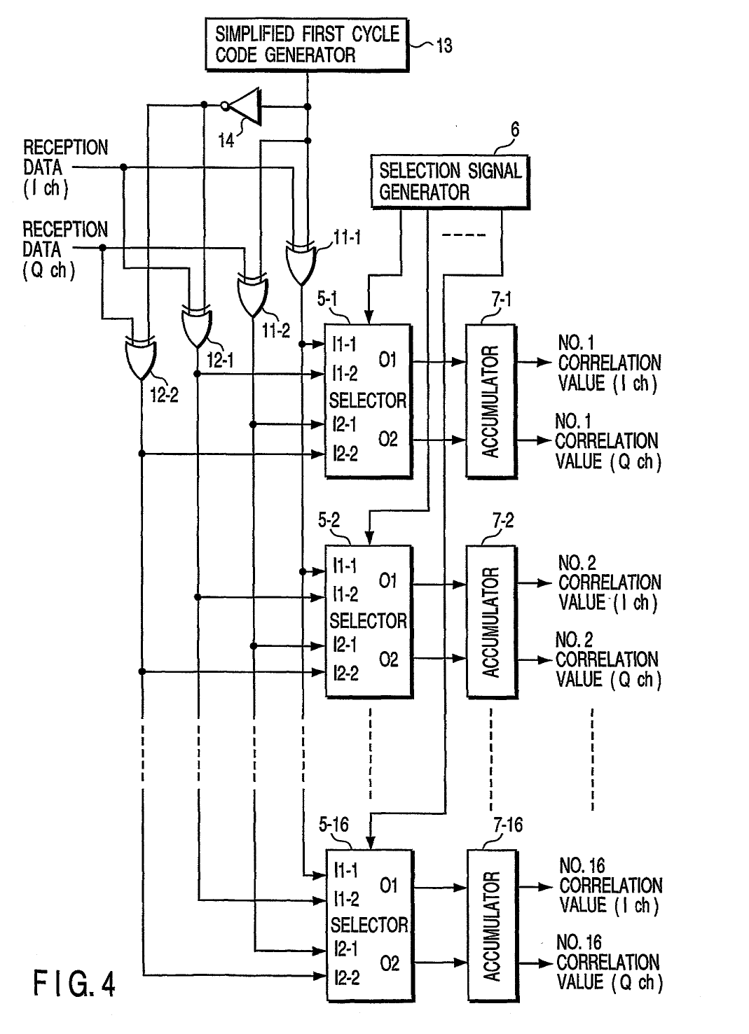

FIG. 4 is a block diagram showing a structure of a second search circuit designed on the basis of a code detection circuit according to this embodiment.

The components identical to those shown in FIG. 1 are designated at the same reference numerals and will not described in detail.

As shown in this drawing, the second search circuit of this embodiment includes: selectors 5; a selection signal generator 6; accumulators 7; EX-OR circuits 11-1 and 11-2; EX-OR circuits 12-1 and 12-2; a simplified first cycle code generator 13; and a logic inverter 14. That is, the EX-OR circuits 11-1 and 11-2, the EX-OR circuits 12-1 and 12-2, the simplified first cycle code generator 13 and the logic inverter 14 are used in place of the multipliers 1 and multipliers 2, the first cycle code generator 3 and the polarity inverter 4 that are incorporated in the first embodiment.

Since the EX-OR circuits 11-1 and 11-2 are similar in function, they will be referred to simply as “EX-OR circuits 11” unless the difference between them in important. By the same token, the EX-OR circuits 12-1 and 12-2 will be referred to as “EX-OR circuits 12”.

I-channel reception data and Q-channel reception data is inputted to the EX-OR circuits 11 and EX-OR circuits 12. That is, the I-channel reception data is inputted to the EX-OR circuits 11-1 and 12-1. Further, the Q-channel reception data is inputted to the EX-OR circuits 11-2 and 12-2. A simplified first cycle code generated by the simplified first cycle code generator 13 is supplied to each of the EX-OR circuits 11. Each EX-OR circuit 12 receives an inverted simplified first cycle code generated by the logic inverter 14. Each of the EX-OR circuits 11 and EX-OR circuits 12 calculates EX-OR of the two inputs. The EX-OR circuits 11 thus execute processing for obtaining the EX-OR of the reception data and the simplified first cycle code. In addition, the EX-OR circuits 12 carry out the processing for obtaining the EX-OR of the reception data and the inverted simplified first cycle code. Here, since the reception data consists of a plurality of bits represented by complements of 2, the EX-OR circuits 11 and EX-OR circuits 12 individually obtain the EX-ORs of the simplified first cycle code or the inverted simplified first cycle code with respect to each bit of the reception data.

An output from the EX-OR circuit 11-1 is supplied to an input terminal I1-i of each of the selectors 5-1 to 5-16. An output from the EX-OR circuit 11-2 is fed to an input terminal I2-1 of each of the selectors 5-1 to 5-16. An output from the EX-OR circuit 12-1 is supplied to an input terminal 11-2 of each of the selectors 5-1 to 5-16. An output from the EX-OR circuit 12-2 is fed to an input terminal I2-2 of each of the selectors 5-1 to 5-16.

The simplified first cycle code generator 13 generates the simplified first cycle code obtained by changing each chip in the above-described first cycle code shown in FIG. 5 from “1” to “0” and “−1” to “1”. The simplified first cycle code generator 13 then outputs the thus produced code in synchronization with a timing of the Secondary Synchronization Code in the reception data.

The logic inverter 14 inverts the logic of each chip in the simplified first cycle code generated by the simplified first cycle code generator 13 to produce the above-described inverted simplified first cycle code. The logic inverter 14 then supplies the obtained code to the EX-OR circuits 12.

Description will now be given as to the operation of the code detection circuit having the above structure.

In the first embodiment, the multipliers 1 first multiply the reception data by the first cycle code. Here, since the first cycle code is a pattern consisting of “1” and “−1”, the multipliers 1 output the reception data without changing the polarity in a period in which the first cycle code is indicative of “1” and output the reception data with the inverted polarity in a period in which the first cycle code is indicative of “−1”.

In this embodiment, the EX-OR circuits 11 obtains the EX-OR of the reception data and the simplified first cycle code. The simplified first cycle code is a code obtained by changing each chip in the first cycle code from “1” to “0” and “−1” to “1”. Therefore, when the simplified first cycle code is “0”, i.e., in a period during which the first cycle code is “1”, the input data is outputted from the EX-OR circuits 11 without any change.

Further, when the simplified first cycle code is “1”, i.e., in a period during which the first cycle code is “−1” the input data is outputted from the EX-OR circuits 11 with each bit of the input data being inverted. Here, since the input data is represented by complements of 2, the output of the EX-OR circuits 11 is substantially equal to a value obtained by inverting the polarity of the input data. It is to be noted that an error of only “1” in the binary digit is produced with respect to an absolute value in a narrow sense, but this error is very small. This can be hence ignored.

On the other hand, in the first embodiment, the multipliers 2 multiply the reception data by the inverted first cycle code. Here, the inverted first cycle code is a pattern obtained by inverting the polarity of each chip in the first cycle code. The multipliers 2, therefore, output the reception data with the inverted polarity in a period during which the first cycle code is “1” and output the reception data without changing the polarity in a period during which the first cycle code is “−1”.

In this embodiment, the EX-OR circuits 12 obtain the EX-OR of the reception data and the inverted simplified first cycle code. Accordingly, when the inverted simplified first cycle code is “0”,, the input data is outputted from the EX-OR circuits 12 without any change. Here, the inverted simplified first cycle code is a code obtained by inverting the logic of each chip in the first cycle code. Thus, the period in which the inverted first cycle code is “0”? is the period in which the simplified first cycle code is “1”, i.e., the first cycle code is “−1”.

When the inverted simplified first cycle code is “1”, i.e., in a period during which the first cycle code is “1”, the input data is outputted from the EX-OR circuits 12 with each bit of the input data being inverted. Here, since the input data is represented by complements of 2, the output of the EX-OR circuits 12 is substantially equal to a value obtained by inverting the polarity of the input data. It is to be noted that an error of only “1” in the binary digit is generated with respect to an absolute value in a narrow sense, but this error is very small. This can be thus ignored.

In this manner, the outputs from the EX-OR circuits 11 and EX-OR circuits 12 become data similarly converted as the outputs from the multipliers 1 and multipliers 2 in the first embodiment.

As described above, executing the following processing similarly as in the first embodiment can obtain appropriate correlation values as outputs of the accumulators 7 for identifying the Hadamard Sequence pattern.

According to this embodiment, since it is enough for the simplified first cycle code generator 13 to produce a code consisting of “0” and “1”. The simplified first cycle code generator 13 can be realized with the simpler structure than that of the fist cycle code generator 3 in the first embodiment which produces the first cycle code having the positive and negative polarities. As a result, it is possible to reduce the circuit scale and an amount of the power consumption.

It is to be noted that the present invention is not restricted to the foregoing embodiments. For example, in each of these embodiments, the above has described the example where the present invention is applied to the second search circuit for obtaining the correlation value concerning the Hadamard Sequence pattern in the Secondary Synchronization Code. However, the code to be processed may be arbitrary if it meets the conditions of the present invention. The present invention can be, therefore, also applied to any circuit other than the second search circuit.

In the second embodiment, the simplified first cycle generator 13 is used for both generation of the simplified first cycle code and that of the inverted simplified first cycle code. However, it is possible to separately provide the code generator which respectively changes each chip in the first cycle code from “1” to “0” and “−1” to “1” to generate a code and another code generator which respectively changes each chip in the first cycle code from “1”, to “1” and “−1” to “0” to produce a code.

In the second embodiment, the simplified first cycle code generator 13 respectively changes each chip in the first cycle code from “1” to “0” and “−1” to “1” to generate a simplified first cycle code, and the logic of each chip in the simplified first cycle code is inverted to produce an inverted simplified first cycle code. However, it is possible to provide a code generator which respectively changes each chip in the first cycle code from “1” to “1” and “−1” to “0” to generate a code so that an output from the code generator can be supplied to the EX-OR circuits 12. Further, the logic inverter may invert the logic of each chip in the output from the code generator to produce a code which is supplied to the EX-OR circuits 11.

Besides, various modifications are possible within the true scope of the present invention.

1. A code detection circuit for obtaining respective correlation values of i types (i is a positive integer not less than 2) of variable patterns to a third code in order to detect one of said i types of variable patterns corresponding to only one variable pattern included in said third code obtained from exclusive ORs of a first code and a second code, wherein under the following conditions:
(1) said first code is constituted by multiplying a first cycle code by a second cycle code;
(2) said first cycle code is obtained by repeatedly arranging n patterns (n is a positive integer) of a first fixed pattern having an m-chip (m is a positive integer) length;
(3) said first fixed pattern is obtained by arranging m chips, each of which is indicative of “1” or “−1”, in a predetermined order;
(4) said second cycle code is constituted by a second fixed pattern having a chip cycle which is m times larger than that of said first cycle code and having an n-chip length;
(5) each chip of said second fixed pattern represents normality/inversion of said first fixed pattern;
(6) said second code is obtained by repeatedly arranging p (p is a positive integer) variable patterns each of which has the same chip cycle as that of said second cycle code and has an n/p-bit length; and
(7) said i types of variable patterns are obtained by arranging n/p bits of “100 or 1111” in each different order,
said code detection circuit comprises:
first code converting means for respectively outputting chips of said third code corresponding to a period in which said first cycle code is “1” without changing the polarity and chips of said third code corresponding to a period in which said first cycle code is “−1” with the polarity being inverted when said first cycle code is synchronized with said third code;
second code converting means for respectively outputting chips of said third code corresponding to a period in which said first cycle code is “1” with the polarity being inverted and chips of said third code corresponding to a period in which said first cycle code is “−1” without changing the polarity when said first cycle code is synchronized with said third code;
selection pattern outputting means for respectively outputting i selection patterns with respect to each of said i types of variable patterns in synchronization with said third code in parallel, said i selection patterns being formed by figuring out exclusive ORs from codes obtained by converting each chip in said second cycle code from “1” to “0” and from “−1” to “1”;
i selecting means which are respectively associated with i selection patterns outputted from said selection pattern outputting means and respectively selects and outputs an output from said first code converting means when an associated selection pattern is “0” and an output from said second code converting means when an associated selection pattern is “1”; and
i accumulating means which are provided so as to be respectively associated with said i selecting means and accumulates an output from an associated selecting means.

2. The code detection circuit according to claim 1, wherein on the premise that said third code has its polarity represented by complements of 2 consisting of a plurality of bits which meet said conditions,
said first code converting means includes:
first simplified code generating means for respectively generating “0” in a period during which said first cycle code is “1” and “1” in a period during which said first cycle code is “−1”; and
first calculating means for obtaining an exclusive OR of an output from said first simplified code generating means and each bit of said third code,
and said second code converting means includes:
second simplified code generating means for respectively generating “1” in a period during which said first cycle code is “1” and “0” in a period during which said first cycle code is “−1”; and
second calculating means for obtaining an exclusive OR of an output from said second simplified code generating means and each bit in said third code.

3. The code detection circuit according to claim 2, wherein said first simplified code generating means and said second simplified code generating means share a single code generation circuit which generates one of “0” and “1” in a period during which said first cycle code is “1” and the other of “0” and “1” in a period during which said first cycle code is “−1”, and
wherein said second simplified code generating means comprises logic inverting means for inverting the logic of an output from said code generation circuit if said code generation circuit outputs “0” in a period during which said first cycle code is “1”, and said first simplified code generating means comprises said logic inverting means if said code generation circuit outputs “1” in a period during which said first cycle code is “1”.

4. A code detection method for obtaining respective correlation values of i types (i is a positive integer not less than 2) of variable patterns to a third code in order to detect one of said i types of variable patterns corresponding to only one variable pattern included in said third code obtained from exclusive ORs of a first code and a second code, wherein under the following conditions:
(1) said first code is constituted by multiplying a first cycle code by a second cycle code;
(2) said first cycle code is obtained by repeatedly arranging n patterns (n is a positive integer) of a first fixed pattern having an m-chip (m is a positive integer) length;
(3) said first fixed pattern is obtained by arranging m chips, each of which is indicative of “1” or “−1”, in a predetermined order;
(4) said second cycle code is constituted by a second fixed pattern having a chip cycle which is m times larger than that of the first cycle code and having an n-chip length;
(5) each chip of said second fixed patter represents normality/inversion of said first fixed pattern;
(6) said second code is obtained by repeatedly arranging p (p is a positive integer) variable patterns each of which has the same chip cycle as that of the second cycle code and has an n/p-bit length; and
(7) said i types of variable patterns are obtained by arranging n/p bits of “0” or “1” in each different order,
said code detection method comprises:
a first code converting step for respectively outputting chips of said third code corresponding to a period in which said first cycle code is “1” without changing the polarity and chips of said third code corresponding to a period in which said first cycle code is “−1” with the polarity being inverted when said first cycle code is synchronized with said third code;
a second code converting step for respectively outputting chips of said third code corresponding to a period in which said first cycle code is “1” with the polarity being inverted and chips of said third code corresponding to a period in which said first cycle code is “−1” without changing the polarity when said first cycle code is synchronized with said third code;
a selection pattern outputting step for respectively outputting i selection patterns with respect to each of said i types of variable patterns in synchronization with said third code in parallel, said i selected patterns being formed by figuring out exclusive ORs from codes obtained by converting each chip in said second cycle code from “1” to “0” and from “−1” to “1”;
a selecting step for respectively selecting and outputting an output from said first code converting step when an associated selected pattern is “0” and an output from said second code converting step when an associated selected pattern is “1”, in accordance with each of i selection patterns outputted at said selection pattern outputting step; and
an accumulating step for respectively accumulating i selection outputs at said selecting step.
